(19) United States
(12) Patent Application Publication
(10) Pub. No.: US 2025/0023296 A1
(43) Pub. Date: Jan. 16, 2025

(54) RELIABLE SOCKET CONNECTOR

(71) Applicant: Amphenol East Asia Limited (Hong Kong), Tsimshatsui (HK)

(72) Inventors: Mei-Chien Wu, Taoyuan City (TW); Lo-Wen Lu, Taoyuan City (TW); Wen Te Hsu, Taoyuan City (TW)

(73) Assignee: Amphenol East Asia Limited (Hong Kong), Tsimshatsui (HK)

(21) Appl. No.: 18/770,943

(22) Filed: Jul. 12, 2024

(30) Foreign Application Priority Data
Jul. 13, 2023 (TW) 112207348

(51) Int. Cl. H01R 13/639; H01R 12/71; H01R 13/627

(52) U.S. Cl. CPC H01R 13/639; H01R 12/716; H01R 13/6271

(57) ABSTRACT

A reliable socket connector. The connector includes an insulative body having a slot recessed from a mating face and terminals disposed in the insulative body having mating ends curving into the slot and tail ends extend thereout. A shell is disposed outside the insulative body. The shell has a mating portion extend beyond the mating face of the insulative body. The shell has a side wall comprising a docking portion and a guiding portion. The docking portion has holes configured for receiving a latch of a mating plug connector. The guiding portion extends beyond the docking portion in a mating direction and is configured for guiding the mating plug connector into the shell where a mating portion of the plug connector may then be guided into the slot of the insulative body.

### CROSS REFERENCE TO RELATED APPLICATIONS

This application claims priority to and the benefit of Taiwan Patent Application Serial No. 112207348, filed on Jul. 13, 2023. The contents of this application are incorporated herein by reference in their entirety.

### TECHNICAL FIELD

This application relates generally to interconnection systems, such as those including electrical connectors, used to interconnect electronic assemblies.

### BACKGROUND

With the advancement of communication technology and electronic technology, electronic devices with various functions, such as: mobile power supply devices that can be carried around to provide continuous power supply for mobile phones, mobile phones that allow people to communicate at both ends of the world, portable music players that allow people to listen to music anytime and anywhere, and personal computers that help people deal with various things, etc., have become indispensable tools in modern people's lives and work.

In addition, to receive electronic signals and power from the outside world, various electronic devices (such as smart phones, tablets, desktop computers, notebook computers, digital cameras, etc.) usually are equipped with connectors in their respective bodies. Generally speaking, the term “connectors” may refer to connecting elements and auxiliary accessories used in electronic signals and power supplies. They are a bridge for all signals; their quality affects the reliability of current and signal transmission, and they are also closely related to the operation of electronic devices. Moreover, through the function of connectors, a plurality of electronic devices can be connected into a complete system, which may transmit electronic signals or power to each other.

### SUMMARY

Aspects of the present disclosure relate to reliable socket connectors.

Some embodiments relate to a shell for a socket connector. The shell may comprise a first side wall comprising a first groove; a second side wall opposite to the first side wall and comprising a second groove; and a third side wall connecting first ends of the first side wall and the second side wall. The third side wall may comprise a first portion and a second portion extending beyond the first portion in a mating direction. The first portion of the third side wall may comprise one or more holes configured to receive a latch of a plug connector. A subportion of the second portion of the third side wall that extends beyond the first portion in the mating direction may bend outwardly so as to guide the plug connector.

Optionally, the shell may comprise a fourth side wall opposite the third side wall and connecting second ends of the first side wall and the second wall, wherein the fourth side wall extends beyond the first portion of the third side wall in the mating direction.

Optionally, a subportion of the fourth side wall that extends beyond the first portion in the mating direction bends outwardly so as to guide the plug connector together with the subportion of the second portion of the third side wall.

Optionally, the first side wall, the second side wall, the third side wall, and the fourth side wall together surround a space configured to receive the plug connector.

Optionally, the first groove is narrower than the first side wall; the first side wall comprises at least one first guiding wall on at least one side of the first side wall; the second groove is narrower than the second side wall; and the second side wall comprises at least one second guiding wall on at least one side of the second side wall.

Optionally, the first portion of the third side wall is disposed between the first side wall and the second portion of the third side wall; and the second portion of the third side wall is disposed between the first portion of the third side wall and the second side wall.

Optionally, the second portion of the third side wall extends less than a half of the third side wall in a width direction perpendicular to the mating direction.

Optionally, the first portion of the third side wall comprises a plurality of holes configured to receive the latch of the plug connector; and the plurality of holes are disposed on one side of a central axis of the third side wall.

Optionally, the subportion comprises a top surface of the second portion bent outwardly.

Some embodiments relate to a socket connector. The socket connector may comprise an insulative body comprising a mating face and a slot recessed into the mating face; a plurality of terminals disposed in the insulative body, each of the plurality of terminals comprising a mating end curving into the slot of the insulative body, a tail end opposite the mating end and extending out of the insulative body, and an intermediate portion joining the mating end and the tail end; and a shell disposed outside the insulative body, the shell comprising a mating portion extending beyond the mating face of the insulative body, and a tail portion comprising a plurality of legs configured to mount to a circuit board. The shell may comprise a side wall comprising a first portion having a plurality of holes and a second portion extending beyond the first portion in a mating direction. The first portion of the side wall of the shell may be rigidly coupled to the insulative body.

Optionally, the side wall of the shell is a first long side wall of the shell; the shell comprises a first short side wall comprising a first groove, and a second short side wall comprising a second groove; and the mating face of the insulative body is disposed below both a bottom of the first groove and a bottom of the second groove.

Optionally, the mating face of the insulative body is disposed below a subportion of the second portion of the side wall that extends beyond the first portion in the mating direction.

Optionally, the tail ends of the plurality of terminals are configured for surface mounting to the circuit board; and the legs of the shell are configured for inserting into holes of the circuit board.

Optionally, the second portion of the side wall comprises a top surface bent in a direction outward from the insulative body; and the second portion is less than half a width of the side wall.

Optionally, the side wall is a first side wall and the shell comprises a second side wall opposite the first side wall.

Optionally, the second side wall comprises a top surface bent in a direction outward from the insulative body and opposite of the direction of the second portion.

Some embodiments relate to a connector assembly. The connector assembly may comprise the socket connector describe herein; and a plug connector comprising a latch having one or more protrusions each fixedly disposed in a respective one of the plurality of holes of the side wall of the shell of the socket connector.

Some embodiments relate to a method of operating a socket connector. The socket connector may comprise a shell and an insulative body disposed in the shell, the insulative body may comprise a slot recessed at a mating face, and the shell may extend beyond the mating face of the insulative body and comprise a first portion and a second portion extending beyond the first portion in a mating direction. The method may comprise engaging a housing of a plug connector with the second portion of the socket connector; and guiding a mating end of the plug connector into the slot of the insulative body of the socket connector with the second portion of the socket connector until a latch of the plug connector engages holes of the first portion of the socket connector.

Optionally, the method further comprises disengaging the latch of the plug connector from the holes of the first portion of the socket connector; and moving the plug connector in the mating direction such that the mating end of the plug connector is removed from the slot of the insulative body of the socket connector.

Optionally, the method further comprises continuing moving the plug connector in the mating direction such that the mating end of the plug connector is removed from the shell of the socket connector.

These techniques may be used alone or in any suitable combination. The foregoing is a non-limiting summary of the application, which is defined by the attached claims.

### BRIEF DESCRIPTION OF DRAWINGS

The accompanying drawings may not be intended to be drawn to scale. In the drawings, each identical or nearly identical component that is illustrated in various figures may be represented by a like numeral. For purposes of clarity, not every component may be labeled in every drawing. In the drawings:

FIG. 1 is a front perspective view of a socket connector, showing a shell with both a guiding portion and a docking portion, according to some embodiments.

FIG. 2 is a rear perspective view of the socket connector of FIG. 1, according to some embodiments.

FIG. 3 is an exploded perspective view of the socket connector of FIG. 1, according to some embodiments.

FIG. 4 is a front view of the socket connector of FIG. 1, according to some embodiments.

FIG. 5 is a cross-sectional view of the socket connector of FIG. 1, according to some embodiments.

FIG. 6 is a top view of the socket connector of FIG. 1, according to some embodiments.

FIG. 7 is an exploded perspective view of a connector assembly, the connector assembly comprising the socket connector of FIG. 1 and an exemplary plug connector configured to mate with the socket connector of FIG. 1, according to some embodiments.

### DETAILED DESCRIPTION

The inventors have recognized and appreciated techniques for making a reliable socket connector. According to aspects of the present disclosure, a connector may include an insulative body having a slot recessed into a mating face and terminals disposed in the insulative body having mating ends curving into the slot and tail ends extending out of the insulative body. A shell may be disposed outside the insulative body. The shell may have a mating portion extending beyond the mating face of the insulative body. The shell may have a side wall comprising a docking portion and a guiding portion. The docking portion may have holes configured for receiving a latch of a mating plug connector. The guiding portion may extend beyond the docking portion in a mating direction and may be configured for guiding the mating plug connector into the shell where a mating potion of the plug connector may then be guided into the slot of the insulative body.

According to aspects of the present disclosure, a shell for a socket connector may include both a docking portion and a guiding portion. The shell may comprise a first short side wall, a second short side wall, a first long side wall and a second long side wall, wherein the first short side wall and the second short side wall are opposite to each other; two sides of the first long side wall are connected to the first short side wall and the second short side wall, respectively, and the first long side wall can be divided into a docking portion and a guiding portion; the docking portion is adjacent to the first short side wall and is provided with a latch hole group; the latch hole group has at least one latch hole; the guiding portion is adjacent to the second short side wall, and the highest horizontal height of a top surface of the guiding portion is higher than the highest horizontal height of a top surface of the docking portion; and the second long side wall is opposite to the first long side wall, and two sides of the second long side wall are connected to the first short side wall and the second short side wall, respectively, such that the first short side wall, the second short side wall, the first long side wall and the second long side wall together surround a space. In this way, when a plug connector is plugged into the socket connector, the guiding portion can perform a guiding function, such that the plug connector is plugged into the connector along the guiding portion until the latch portion of the plug connector is embedded in the corresponding latch hole, making the plug connector stably coupled to the socket connector.

According to aspects of the present disclosure, a socket connector may include the shell as described above, an insulative housing and at least one terminal group, wherein the insulative body can be accommodated in a space of the shell, and the insulative body is internally provided with at least one slot; a top end of the insulative body is provided with at least one mating interface, and the mating interface can be in communication with the corresponding slot; and at least one terminal group can be disposed in the insulative body and comprises a plurality of terminals, and one end of each of the terminals can be exposed from the slot.

The present disclosure will be further described in detail below in conjunction with exemplary embodiments and with reference to the drawings. It is to be appreciated that various alterations, modifications, and improvements will readily occur to those skilled in the art. Various details in the present disclosure may also be based on different viewpoints and applications, and various modifications and changes may be made without departing from the concept of the present disclosure. In addition, it should be stated in advance that the drawings of the present disclosure may be simple illustrations and may not be depictions based on actual size. In addition, unless otherwise clearly indicated or defined in the context, the meanings of “a” and “the” in the present disclosure include the plural. In addition, the relevant technical contents of the present disclosure will be further described in detail by the following embodiments, but the disclosed contents are not intended to limit the scope of protection of the present disclosure.

It should be understood that the terms used herein generally have their ordinary meanings in the art, and in the event of conflict, any definitions given herein shall prevail. Since the same thing can be expressed in many ways, alternative words and synonyms may be used for any term discussed or described herein, and there is no particular limitation as to whether the term is stated or discussed herein. The use of one or more synonyms should not exclude the use of other synonyms. The embodiments used anywhere in the description of the present disclosure, including the use of any terms, may be illustrative and may not limit the scope and meaning of the present disclosure or any terms. Likewise, the present disclosure is not limited to various embodiments disclosed in the description. Although the terms such as first, second or third may be used herein to describe various elements, the elements may not be limited by the foregoing terms. The foregoing terms are mainly used to distinguish one element from another element and should not impose any substantial limitations on any element, and should not limit the assembly or arrangement sequence of the elements in practical applications. In addition, the direction terms mentioned in the embodiments, such as “up”, “down”, “front”, “back”, “left”, and “right”, are only for reference to the directions in the drawings. Therefore, the use of the directional terms is for illustrative purposes and is not intended to limit the scope of protection of the present disclosure. In addition, the term “or” used herein shall include any one or combination of more of associated listed items, depending on actual situations.

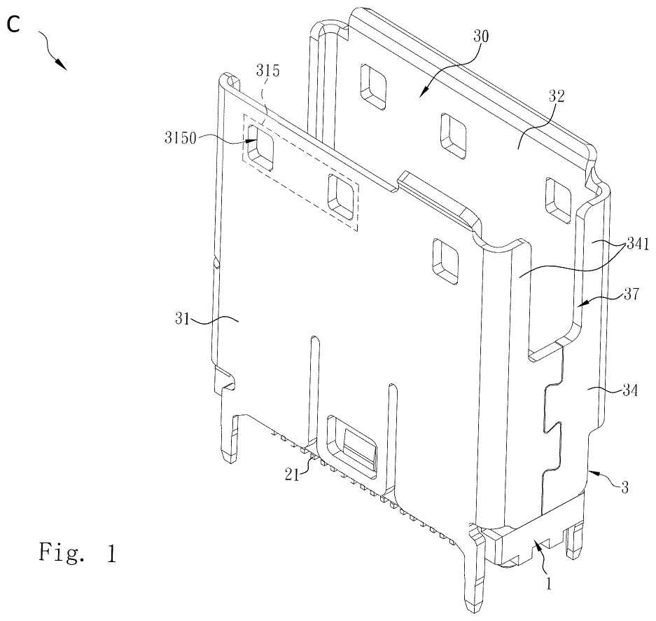

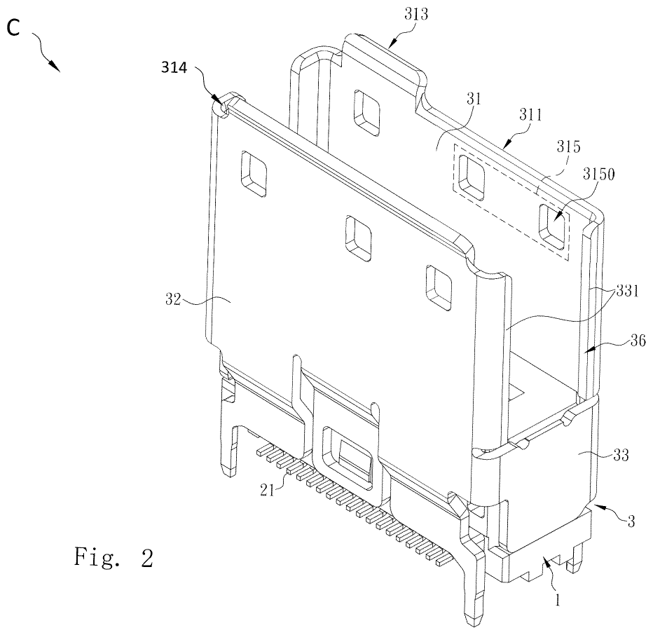

The present disclosure relates to a socket connector having a shell that has both a docking portion and a guiding portion. In one embodiment, referring to FIGS. 1 to 3, the connector includes an insulative body 1, at least one terminal group 2 and a shell 3. For convenience of description, the upper side of FIG. 1 is taken as the upper (top) side of an element, the lower side of FIG. 1 is taken as the lower (bottom) side of the element, the lower left side of FIG. 1 is taken as the front side of the element, the upper right side of FIG. 1 is taken as the rear side of the element, the upper left side of FIG. 1 is taken as the left side of the element, and the lower right side of FIG. 1 is taken as the right side of the element. In addition, the insulative body 1 is internally provided with a slot 10, one end (e.g., the top end) thereof is provided with a mating interface 11, and the mating interface 11 can be in communication with the slot 10. However, in other embodiments of the present disclosure, the insulative body 1 can be provided with a plurality of mating interfaces 11, and the mating interfaces 11 can be in communication with the same slot 10; or, the insulative body 1 can be provided with a plurality of mating interfaces 11 and a plurality of slots 10, and the mating interfaces 11 can be in communication with respective slots 10.

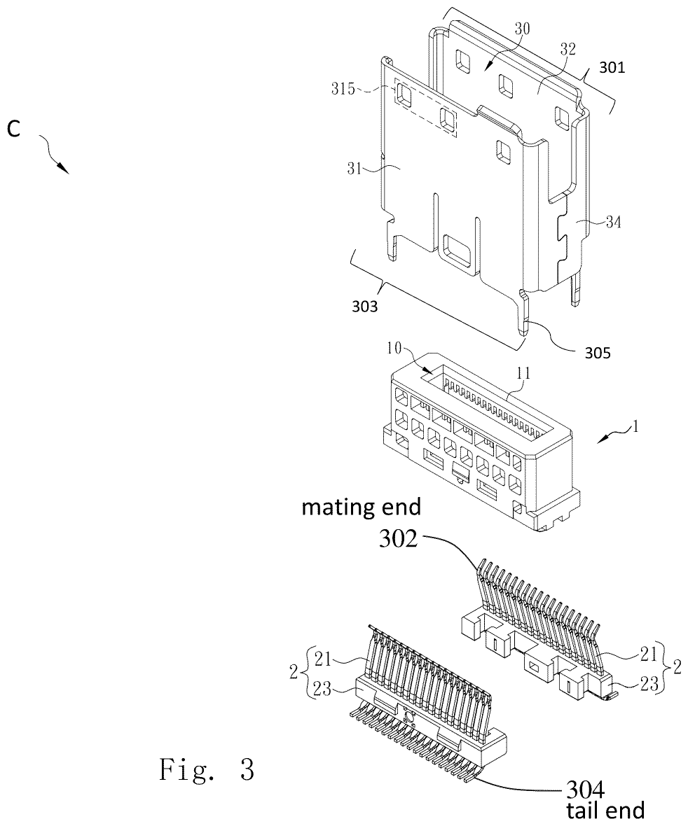

In addition, referring back to FIG. 1, the terminal group 2 can be assembled into the insulative body 1 and includes at least a plurality of terminals 21. Each of the terminals 21 can be a power terminal, a signal terminal, a ground terminal or other suitable terminal type according to its function, and the terminals 21 included in the same terminal group 2 can all be terminals with the same function (for example: all are power terminals), or can be mixed terminals with different functions (for example: both a signal terminal and a ground terminal are provided). Also, after the terminal group 2 is assembled to the insulative body 1, one end of the terminals 21 can be exposed from the slot 10 so as to be electrically connected to metal terminals of other connectors (for example: plug connector(s)). As shown in FIG. 3, each of terminals 21 may include a mating end 302 configured to be electrically connected to terminals of other connectors. In some embodiments, the mating end 302 may curve into the slot of the insulative body 1. Each of terminals 21 may include tail ends 304 extending out of a surface of the insulative body 1 (e.g., the bottom surface) to be electrically connected to a circuit board. In some embodiments an intermediate portion may join the mating ends 302 and tail ends 304 of each terminal 21. In some embodiments, the connector is provided with two terminal groups 2, and each terminal group 2 may include a plurality of terminals 21 and a terminal base 23. Each terminal 21 is fixed to the terminal base 23. The terminal bases 23 of the two terminal groups 2 can be integrated with each other into one body, such that they can be more conveniently assembled into the insulative body 1.

Furthermore, referring back to FIGS. 1 to 3, the shell 3 includes a mating end 301 extending beyond the mating interface 11 of the insulative body 1 and a tail portion 303 having a plurality of legs 305 configured to mount the shell 3 to a circuit board. The shell 3 includes a first long side wall 31, a second long side wall 32, a first short side wall 33 and a second short side wall 34, wherein the first long side wall 31 can be used as a front side wall of the shell 3, and two sides (left and right sides) thereof are connected to the first short side wall 33 and the second short side wall 34, respectively, and the second long side wall 32 can be used as a rear side wall of the shell 3, and two sides (left and right sides) thereof are connected to the first short side wall 33 and the second short side wall 34, respectively, such that the first short side wall 33 can be used as a left side wall of the shell 3, the second short side wall 34 can be used as a right side wall of the connector 3, and the first long side wall 31, the second long side wall 32, the first short side wall 33 with the second short side wall 34 together can surround a space 30.

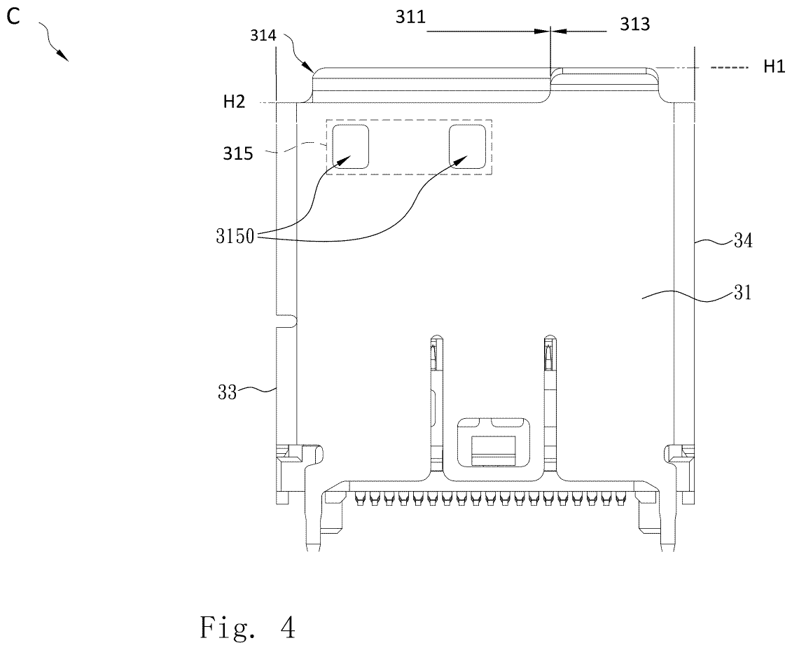

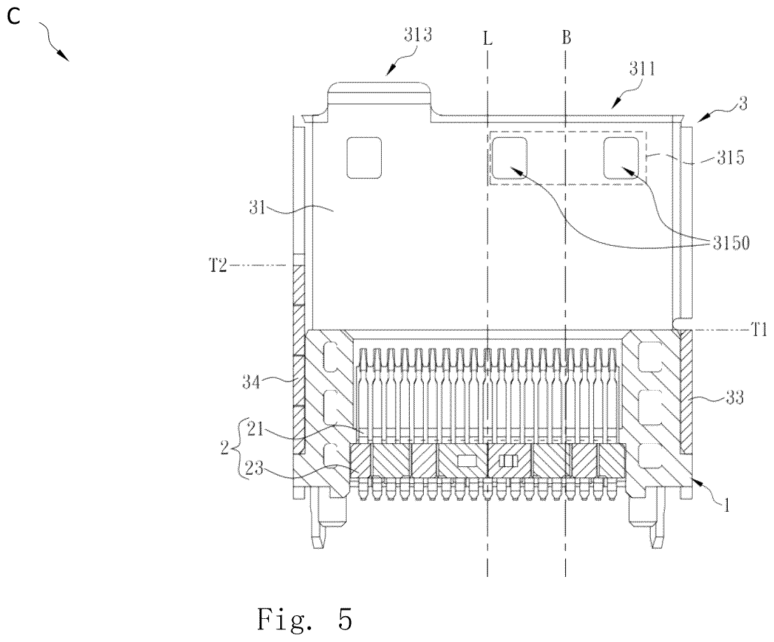

Referring to FIGS. 1 to 4, the first long side wall 31 can be divided into a docking portion 311 and a guiding portion 313, wherein the docking portion 311 is adjacent to the first short side wall 33, the guiding portion 313 is adjacent to the second short side wall 34, and the highest horizontal height H1 of a top surface of the guiding portion 313 is higher than the highest horizontal height H2 of a top surface of the docking portion 311. In some embodiments, the second long side wall 32 may include a guiding portion 314. Guiding portion 314 may extend along substantially an entire width of the second long side wall 32, or a portion of the width of long side wall 32. The first long side wall 31 is provided with a latch hole group 315 in a region corresponding to the docking portion 311. The latch hole group 315 has at least one latch hole 3150, and the latch hole 3150 can run through the inner surface and the outer surface of the first long side wall 31. For example, the latch hole 3150 can be in communication with the space 30. In some embodiments, referring to FIG. 5, the position of the central axis B of the latch hole group 315 deviates from the main central axis L of the first long side wall 31. Taking FIG. 5 as an example, the latch hole group 315 includes two latch holes 3150. Therefore, the outermost positions of the two latch holes 3150 are essentially equivalent to the edges of the latch hole group 315, and the central axis B thereof is the middle position of the two opposite edges mentioned previously. Also, the main central axis L of the first long side wall 31 is at the middle position of its total width. In some embodiments, all the latch holes 3150 of the latch hole group 315 are located on one side of the main axis L of the first long side wall 31, but the technology described herein is not limited in this regard.

Continuing with the above and referring back to FIGS. 1 to 4, in this embodiment, the top surface of the guiding portion 313 can be bent and folded in a direction away from the space 30. It should be appreciated that the technology described herein is not intended to be limited in that manner, for example, guiding portion 314 can be bent and folded in a direction away from space 30 and opposite the direction of guiding portion 313. When a plug connector is plugged into the socket connector C, the guiding portion 313 can first contact the plug connector, such that the plug connector is plugged into the socket connector C from top to bottom along the top of the guiding portion 313 until a latch portion of the plug connector is embedded in the corresponding latch hole 3150, making the plug connector stably coupled to the socket connector C. In addition, with the design of the latch hole 3150, when pulling out the plug connector, a user usually needs to perform an unlocking action first. Therefore, the user needs to operate the latch portion of the plug connector such that the latch portion can be separated from the corresponding latch hole 3150. To provide the user with more operating space for unlocking, in this embodiment, the width of the guiding portion 313 can be less than half of the total width of the first long side wall 31. In this way, when the guiding portion 313 exerts the expected guiding effect, its upward extending portion occupies less space to provide more space for the user to operate and unlock.

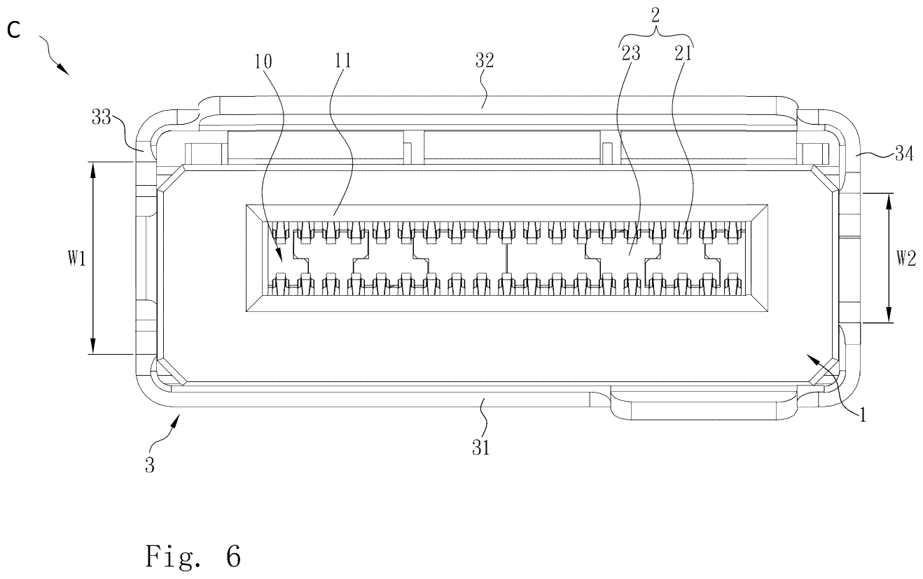

In addition, in this embodiment, referring back to FIGS. 1 to 3 and 6, the first short side wall 33 is recessed with a first groove 36 from top to bottom, the second short side wall 34 is recessed with a second groove 37 from top to bottom, and the width W2 of the second groove 37 can be smaller than the width W1 of the first groove 36, which may achieve a fool-proofing effect and ensure that the plug connector only can be plugged into the socket connector C in a correct manner, but the technology described herein is not limited in that manner. In other embodiments, the widths W1 and W2 of the first groove 36 and the second groove 37 can be the same. Furthermore, in this embodiment, the width W1 of the first groove 36 can be smaller than the width of the first short side wall 33 to form at least a first guiding wall 331, and the width W2 of the second groove 37 can be is smaller than the width of the second short side wall 34 to form at least one second guiding wall 341. In this way, when a plug connector is plugged into the socket connector C, the first guiding wall 331 and the second guiding wall 341 can each cover a corresponding outer wall of the plug connector to likewise perform the guiding function. In this embodiment, it is taken as an example that the shell 3 has two first guiding walls 331, and the widths of the two first guiding walls 331 are the same, but the technology is not limited in that manner. The widths of the two guiding walls 331 can be different from each other. Similarly, the widths of the two second guiding walls 341 provided on the housing 3 can also be the same or different.

Furthermore, referring back to FIG. 5, the horizontal height T1 of the bottom of the first groove 36 can be lower than the horizontal height T2 of the bottom of the second groove 37, but the technology is not limited in that manner. In some embodiments, the bottom of the first groove 36 and the second groove 37 may have the same height. Also, one end (top end) of the insulative body 1 may not exceed the bottom of the first groove 36 and/or the second groove 37. Therefore, when a plug connector is plugged into the socket connector C, the plugging regions of the two can be completely within space 30 in the housing 3 without being exposed, which may obtain good protection and a shielding effect. However, in other embodiments of the present disclosure, one end of the insulative body 1 may be flush with or exceed the height of the bottom of the first groove 36 and/or the second groove 37, but may not exceed the top surface of the guiding portion 313.

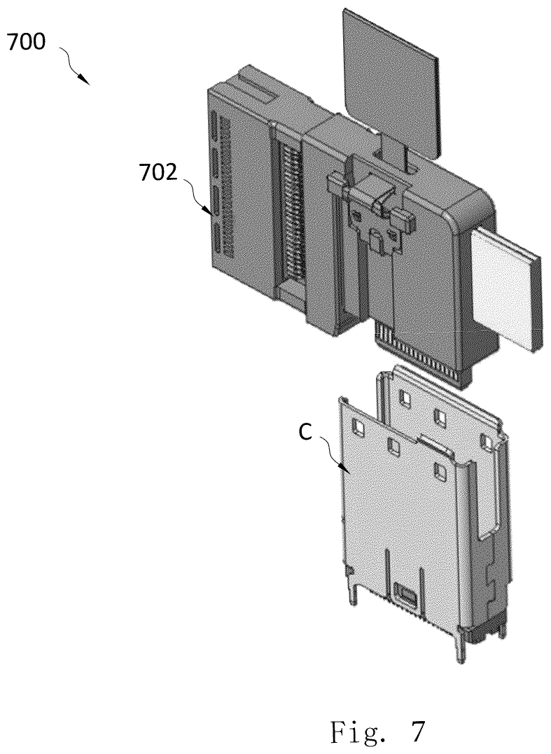

Some aspects described herein provide a method of operating a connector as described herein with respect to FIGS. 1-3. FIG. 7 further shows an exploded perspective view of a connector assembly 700. The connector assembly 700 includes the socket connector C and an exemplary plug connector 702 configured to mate with the socket connector C, according to some embodiments.

In some embodiments, the method of operating the connector C may include engaging the housing of the plug connector 702 with the guiding portion 313 (e.g., with the top surface of guiding portion 313. The method may further include guiding a mating end of the plug connector 702 into the insulative body 1. In some embodiments, guiding the mating end of the plug connector 702 may include using the guiding portion 313 to moving the mating end of the plug connector 702 into slot 10 of the insulative body 1. In some embodiments, the mating end of the plug connector may be moved until a latch of the plug connector 702 engages latch hole(s) 3150 of the shell 3.

In some embodiments, the method of operating the connector may include removing the plug connector 702 from the connector C. For example, removing the plug connector 702 may include disengaging the latch of the plug connector 702 from latch hole(s) 3150 of the shell 3 and moving the plug connector 702 in the mating direction so as to remove the mating end of the plug connector 702 from the slot 10 of the insulative body 1 of the connector. Removing the plug connector 702 may further include continuing to move the plug connector 702 in the mating direction so that the mating end of the plug connector 702 is removed from the shell 3 of the connector C.

Some embodiments described herein relate to a shell that has both a docking portion and a guiding portion, which is applied to a connector. Optionally, the shell may include: a first short side wall; a second short side wall opposite to the first short side wall; a first long side wall, two sides of the first long side wall being connected to the first short side wall and the second short side wall, respectively, wherein the first long side wall is divided into a docking portion and a guiding portion, the docking portion is adjacent to the first short side wall and is provided with a latch hole group, the latch hole group has at least one latch hole, the guiding portion is adjacent to the second short side wall, and the highest horizontal height of a top surface of the guiding portion is higher than the highest horizontal height of a top surface of the docking portion; and a second long side wall opposite the first long side wall, two sides of the second long side wall being connected to the first short side wall and the second short side wall, respectively, such that the first short side wall, the second short side wall, the first long side wall and the second long side wall together surround a space.

Optionally, a width of the guiding portion is less than half of a total width of the first long side wall.

Optionally, a position of a central axis of the buckle hole group deviates from that of a main axis of the first long side wall.

Optionally, a top surface of the guiding portion is bent and folded in a direction away from the space.

Optionally, the first short side wall is provided with a first groove, the second short side wall is provided with a second groove, and a width of the second groove is smaller than a width of the first groove.

Optionally, the width of the first groove is smaller than a width of the first short side wall to form at least a first guiding wall, and the width of the second groove is smaller than a width of the second short side wall to form at least one second guiding wall.

Some embodiments described herein relate to an electrical connector that has both a docking portion and a guiding portion. Optionally, the electrical connector comprises the shell as described herein; an insulative body, which can be accommodated in the space of the shell, wherein the insulative body is internally provided with at least one slot, a top end of the insulative body is provided with at least one mating interface, and the mating interface can be in communication with the corresponding slot; and at least one terminal group disposed in the insulative body and comprising a plurality of terminals, wherein one end of each of the terminals can be exposed from the slot.

Optionally, the top end of the insulating body does not exceed the top surface of the guiding portion.

Optionally, the top end of the insulating body does not exceed the bottom of the first groove and the second groove.

Although the preferred embodiments of the present disclosure are described above, the scope as claimed by the present disclosure is not limited thereto. According to the technical content disclosed by the present disclosure, a person of ordinary skill in the art can conceive of equivalent changes without departing from the scope of protection of the present disclosure.

The present disclosure is not limited to the details of construction or the arrangements of components set forth in the foregoing description and/or the drawings. Various embodiments are provided solely for purposes of illustration, and the concepts described herein are capable of being practiced or carried out in other ways. Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A shell for a socket connector, the shell comprising:
a first side wall comprising a first groove;
a second side wall opposite to the first side wall and comprising a second groove; and
a third side wall connecting first ends of the first side wall and the second side wall, wherein:
the third side wall comprises a first portion and a second portion extending beyond the first portion in a mating direction;
the first portion of the third side wall comprises one or more holes configured to receive a latch of a plug connector; and
a subportion of the second portion of the third side wall that extends beyond the first portion in the mating direction bends outwardly so as to guide the plug connector.

2. The shell of claim 1, comprising:
a fourth side wall opposite the third side wall and connecting second ends of the first side wall and the second wall,
wherein the fourth side wall extends beyond the first portion of the third side wall in the mating direction.

3. The shell of claim 2, wherein:
a subportion of the fourth side wall that extends beyond the first portion in the mating direction bends outwardly so as to guide the plug connector together with the subportion of the second portion of the third side wall.

4. The shell of claim 2, wherein:
the first side wall, the second side wall, the third side wall, and the fourth side wall together surround a space configured to receive the plug connector.

5. The shell of claim 1, wherein:
the first groove is narrower than the first side wall;
the first side wall comprises at least one first guiding wall on at least one side of the first side wall;
the second groove is narrower than the second side wall; and
the second side wall comprises at least one second guiding wall on at least one side of the second side wall.

6. The shell of claim 5, wherein:
the first portion of the third side wall is disposed between the first side wall and the second portion of the third side wall; and
the second portion of the third side wall is disposed between the first portion of the third side wall and the second side wall.

7. The shell of claim 1, wherein:
the second portion of the third side wall extends less than a half of the third side wall in a width direction perpendicular to the mating direction.

8. The shell of claim 1, wherein:
the first portion of the third side wall comprises a plurality of holes configured to receive the latch of the plug connector; and
the plurality of holes are disposed on one side of a central axis of the third side wall.

9. The shell of claim 1, wherein the subportion comprises a top surface of the second portion bent outwardly.

10. A socket connector comprising:
an insulative body comprising a mating face and a slot recessed into the mating face;
a plurality of terminals disposed in the insulative body, each of the plurality of terminals comprising a mating end curving into the slot of the insulative body, a tail end opposite the mating end and extending out of the insulative body, and an intermediate portion joining the mating end and the tail end; and
a shell disposed outside the insulative body, the shell comprising a mating portion extending beyond the mating face of the insulative body, and a tail portion comprising a plurality of legs configured to mount to a circuit board,
wherein:
the shell comprises a side wall comprising a first portion having a plurality of holes and a second portion extending beyond the first portion in a mating direction; and
the first portion of the side wall of the shell is rigidly coupled to the insulative body.

11. The socket connector of claim 10, wherein:
the side wall of the shell is a first long side wall of the shell;
the shell comprises a first short side wall comprising a first groove, and a second short side wall comprising a second groove; and
the mating face of the insulative body is disposed below both a bottom of the first groove and a bottom of the second groove.

12. The socket connector of claim 10, wherein:
the mating face of the insulative body is disposed below a subportion of the second portion of the side wall that extends beyond the first portion in the mating direction.

13. The socket connector of claim 10, wherein:
the tail ends of the plurality of terminals are configured for surface mounting to the circuit board; and
the legs of the shell are configured for inserting into holes of the circuit board.

14. The socket connector of claim 10, wherein:
the second portion of the side wall comprises a top surface bent in a direction outward from the insulative body; and
the second portion is less than half a width of the side wall.

15. The socket connector of claim 14, wherein:
the side wall is a first side wall and the shell comprises a second side wall opposite the first side wall.

16. The socket connector of claim 15, wherein:
the second side wall comprises a top surface bent in a direction outward from the insulative body and opposite of the direction of the second portion.

17. A connector assembly comprising:
the socket connector of claim 10; and
a plug connector comprising a latch having one or more protrusions each fixedly disposed in a respective one of the plurality of holes of the side wall of the shell of the socket connector.

18. A method of operating a socket connector, wherein the socket connector comprises a shell and an insulative body disposed in the shell, the insulative body comprises a slot recessed at a mating face, and the shell extends beyond the mating face of the insulative body and comprises a first portion and a second portion extending beyond the first portion in a mating direction, the method comprising:
engaging a housing of a plug connector with the second portion of the socket connector; and
guiding a mating end of the plug connector into the slot of the insulative body of the socket connector with the second portion of the socket connector until a latch of the plug connector engages holes of the first portion of the socket connector.

19. The method of claim 18, further comprising:
disengaging the latch of the plug connector from the holes of the first portion of the socket connector; and
moving the plug connector in the mating direction such that the mating end of the plug connector is removed from the slot of the insulative body of the socket connector.

20. The method of claim 19, further comprising:
continuing moving the plug connector in the mating direction such that the mating end of the plug connector is removed from the shell of the socket connector.
